(19) United States
(12) Patent Application Publication
(10) Pub. No.: US 2026/0186807 A1
(43) Pub. Date: Jul. 2, 2026

(54) DATA PROCESSING METHOD AND ELECTRONIC DEVICE

(71) Applicant: Lenovo (Beijing) Limited, Beijing (CN)

(72) Inventors: Yanan CUI, Beijing (CN); Hongyu WANG, Beijing (CN)

(21) Appl. No.: 19/421,888

(22) Filed: Dec. 16, 2025

(30) Foreign Application Priority Data
Dec. 31, 2024 (CN) 202411987373.2

(51) Int. Cl. G06F 9/451; G06F 40/279; G06F 40/30

(52) U.S. Cl. CPC G06F 9/452; G06F 40/279; G06F 40/30

(57) ABSTRACT

A data processing method includes detecting first interaction data input to a first application of an electronic device, and response to the first interaction data meeting a target trigger condition, outputting a target function service option in a target area of the electronic device, the target function service option being an option provided by a target processing model or a target application of the electronic device for performing a target processing operation on target data, and the target data coming from the first interaction data or second interaction data that is different from the first interaction data.

### CROSS-REFERENCES TO RELATED APPLICATION

This application claims priority to Chinese Patent Application No. 202411987373.2 filed on Dec. 31, 2024, the entire content of which is incorporated herein by reference.

### FIELD OF TECHNOLOGY

The present disclosure relates to the field of data processing technology and, more specifically, to a data processing method and an electronic device.

### BACKGROUND

With the continuous development of artificial intelligence technology, users often need to use artificial intelligence models such as large language models to process data.

However, to use artificial intelligence models, users need to first open a specific application configured with the artificial intelligence model and use the specific application to implement the corresponding data processing, which makes the data processing more complex.

### SUMMARY

One aspect of this disclosure provides a data processing method. The data processing method includes detecting first interaction data input to a first application of an electronic device, and in response to the first interaction data meeting a target trigger condition, outputting a target function service option in a target area of the electronic device. The target function service option is an option provided by a target processing model or a target application of the electronic device for performing a target processing operation on target data, and the target data comes from the first interaction data or second interaction data that is different from the first interaction data.

Another aspect of this disclosure provides an electronic device. The electronic device includes one or more processors and one or more large model files to be run on the more of more processors. The one or more large model files, when ran by one or more applications running on the electronic device, cause the one or more processors to detect first interaction data input to a first application of the electronic device, and in response to the first interaction data meeting a target trigger condition, output a target function service option in a target area of the electronic device. The target function service option is an option provided by a target processing model or a target application of the electronic device for performing a target processing operation on target data, and the target data comes from the first interaction data or second interaction data that is different from the first interaction data.

Another aspect of this disclosure provides an electronic device. The electronic device includes one or more processors, and one or more memories coupled to the one or more processors and storing a plurality of computer instructions. The plurality of computer instructions that, when being executed, cause the one or more processors to detect first interaction data input to a first application of the electronic device, and in response to the first interaction data meeting a target trigger condition, output a target function service option in a target area of the electronic device. The target function service option is an option provided by a target processing model or a target application of the electronic device for performing a target processing operation on target data, and the target data comes from the first interaction data or second interaction data that is different from the first interaction data.

### BRIEF DESCRIPTION OF THE DRAWINGS

The above-described and other features, advantages and aspects of the embodiments of the present disclosure will become more evident in combination with the accompanying drawings and with reference to the following specific embodiments. Throughout the drawings, the same or similar reference numerals represent the same or similar elements. It should be understood that the drawings are schematic and that the components and elements are not necessarily drawn to scale.

FIG. 1 is a flowchart of a data processing method according to some embodiments of the present disclosure.

FIG. 2 is a flowchart of the data processing method according to some embodiments of the present disclosure.

FIG. 3 is a flowchart of the data processing method in an application scenario according to some embodiments of the present disclosure.

FIG. 4 is a flowchart of the data processing method according to some embodiments of the present disclosure.

FIG. 5 is a flowchart of the data processing method according to some embodiments of the present disclosure.

FIG. 6 is a flowchart of the data processing method in another application scenario according to some embodiments of the present disclosure.

FIG. 7 is a flowchart of the data processing method according to some embodiments of the present disclosure.

FIG. 8 is a schematic structural diagram of an electronic device according to some embodiments of the present disclosure.

### DETAILED DESCRIPTION

The following describes the embodiments of the present disclosure with reference to the accompanying drawings. The terms used in the embodiments of the present disclosure are only used to explain the specific embodiments of the present disclosure, and are not intended to limit the present disclosure. One of ordinary skilled in the art may learn that, with technology development and emergence of a new scenario, the technical solutions provided in embodiments of the present disclosure are also applicable to a similar technical problem.

In this specification, claims, and accompanying drawings of the present disclosure, the terms “first”, “second”, and the like are intended to distinguish between similar objects but do not necessarily indicate a specific order or sequence. It should be understood that the terms used in such a way are interchangeable in proper circumstances, and this is merely a discrimination manner for describing objects having a same attribute in embodiments of the present disclosure. In addition, the terms “include”, “contain” and any other variants mean to cover the non-exclusive inclusion such that a process, method, system, product, or device that includes a series of units is not necessarily limited to those units, but may include other units not expressly listed or inherent to such a process, method, system, product, or device.

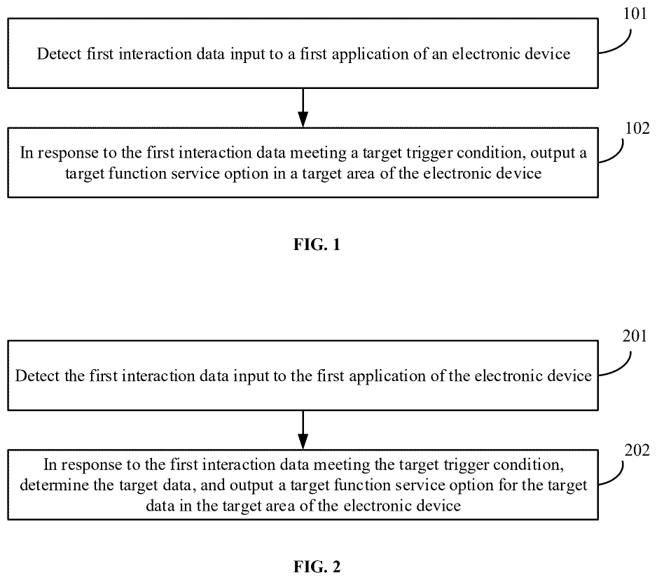

FIG. 1 is a flowchart of a data processing method according to some embodiments of the present disclosure. The data processing method can be applied to electronic devices such as laptops, tablet computers, mobile phones, desktop computers, etc. The method will be described in detail below.

101, detecting first interaction data input to a first application of an electronic device.

The first application may be an application currently being used by the user, or any application currently having input. The type of the first application is not limited in the present disclosure. For example, the first application can be a document application, a presentation application, a mailbox application providing email services, an instant messaging application, an image editing application, a drawing application, an image generation application, a browser application, a social application, a conference application, or a live broadcast application for live video broadcasting, etc. Of course, the first application can also be at least one pre-specified application to be monitored.

There are many implementations for detecting whether there is first interaction data input to the first application.

For example, the hook technology in the operating system may be used to detect whether the application in the electronic device has the first interactive data input. Take the operating system of the electronic device as Windows system as an example. The Windows hook technology can be used to detect various applications in the electronic device to timely detect the first interaction data input in the first application.

In another example, the first application may be monitored for input of the first interaction data by calling the application program interface of the first application.

In another example, the first application that has the first interactive data input may be determined by monitoring the identification information of an active driver.

Of course, there may be other detection methods, which are not limited in the present disclosure.

In some embodiments, the first interactive data may be the data input into the first application. The specific data form of the first interactive data is not limited in the present disclosure. For example, the first interaction data can be a string, voice data, handwriting image data, input gesture data, sensor data or action image, etc.

102, in response to the first interaction data meeting a target trigger condition, outputting a target function service option in a target area of the electronic device.

In some embodiments, the first interaction data meeting the target trigger condition may indicate that the first application needs to process data with a processing model or AI function services. There are many possibilities for the target triggering condition, which can be set based on actual needs. For example, the first interaction data meeting the target trigger condition may include the detection a set target character string, a set gesture action, a set voice signal, or a set handwriting content. For example, the first interactive data may include a set target character string, a set gesture action, a set voice signal or a set handwriting content. Alternatively, a set target character string, a set gesture action, a set voice signal, or a set handwriting content may be present after the first interaction data. Several application scenarios will be used as example in the following description, which will not be described in detail here.

In some embodiments, the target function service option may be an option that can be provided by a target processing model or a target application of the electronic device for performing a target processing operation on the target data.

In some embodiments, the target data may come from the first interaction data or from second interaction data different from the first interaction data.

In some embodiments, the target data may be at least part of the first interaction data. For example, when the first interaction data includes a set target character string, a set gesture action, a set voice signal or a set handwriting content that makes the first interaction data meet the target trigger condition, the target data may be data in the first interaction data that is input before setting the target character string, the gesture action, the voice signal, or the handwriting content (e.g., the data may be the last character string, the voice signal, or gesture input at the most recent set time, etc.).

In some embodiments, the target data may come from the second interaction data. The second interaction data may be data input into the first application before the first interaction data, or may be data obtained after the first interaction data and originating from other applications other than the first application.

Of course, there may be other possibilities for the target data, which will be described in detail in several cases later and will not be repeated here.

In some embodiments, the target processing model may be a local model of the electronic device, or a model located in the cloud or on an edge device. The target processing model may be any type of artificial intelligence model. For example, the target processing model may include at least one of an image generation model, a large language model, or other machine learning models.

In some embodiments, the target application may be an application that can call a target processing model, or an application that can provide a processing operation corresponding to a target functional service option.

The target processing model or the target application can perform a variety of target processing operations on the target data, which may vary depending on the function of the target processing model or the data processing function configured by the target application.

For example, the target processing operations that can be performed by the target processing model or target application may include, but are not limited to, translation, search, semantic interpretation, image generation, writing, video generation, image editing, image redrawing, information search, content answering, and sentence replying operations with the help of artificial intelligence.

Correspondingly, based on the target processing model or the type of target processing operations that the target application can perform, their type of target function service options may also have many possibilities. Based on this, the target function service options that may be output in the present disclosure may be a list or a set of target function service options, and the list or the set may include at least one target function service option.

In some embodiments, the target area may be located within the window area of the first application or may not be located within the window area of the first application.

For example, the target area can be a part of the window area of the first application. In this case, the target area may belong to the same layer as the window area of the first application. For example, the target area may be an embedded window area or a segmented area within the window area. The target area can also be in a different layer from the window area of the first application. For example, the target area can be a floating pop-up window area located within the application window coverage.

In another example, the target area may be a pop-up window area that may be located outside the coverage range of the window area of the first application, or a window area of another form.

The technical solution of the present disclosure can be executed by a specific application (such as a target application) other than the first application to enable the specific application to detect the first application and provide artificial intelligence services to the first application in a timely manner.

Consistent with the present disclosure, after detecting the first interaction data input to the first application of the electronic device, if the first interaction data meets the target trigger condition, the target function service option can be output in the target area of the electronic device. Since the target function service option is an option corresponding to the target processing operation that the target processing model or target application can provide, the user is using the first application, there is no need for the user to launch other specific applications separately. In this way, the relevant data in the first application can be processed with the help of the processing model or the target application, which improves the convenience of data processing.

In some embodiments, after outputting the target function service option, in response to the target function service option being triggered, whether the target function service option is triggered may also be detected. For example, if it is detected that the user clicks or selects the target function option through other means, the target processing operation corresponding to the triggered target function service option may be performed on the target data through the target processing model or target application.

For example, if the target function service option is a translation option, after the target function service option is triggered, the target data can be translated through the target processing model or the target application.

In some embodiments, the processing result data corresponding to the target data in the electronic device may also be displayed. For example, the target data may be displayed at the position of the input point such as the cursor in the first application when the target trigger condition is met; or the target data may be displayed at the current position of the input point such as the cursor in the first application.

In some embodiments, the target data may be displayed in the window area of the second application. The second application may be the application to which the application jumps to when the target trigger condition is met. For example, the second application may be the target application. In this case, the second application can process the target data and obtain the processing result data. The processing result data can be displayed in the window area of the second application. The second application may also be the application where the cursor or other input point is currently located. For example, after the first interaction data meets the target trigger condition, the user moves the cursor from the first application to the second application. In this case, the processing result data obtained by the target processing model or the target application can be displayed at the location of the input point in the second application.

Of course, after obtaining the processing result data corresponding to the target data, the processing result data corresponding to the target data may be directly stored instead of being displayed. For example, the processing result data can be stored in a storage area corresponding to a storage address preset by the user.

The following describes several possible situations in which the first interaction data is considered as meeting the target triggering condition in the present disclosure.

In some embodiments, in response to detecting the input of target character string data, determine that the first interaction data meets the target trigger condition.

The target character string data may be set character string data used to wake up the artificial intelligence function service. The length and specific content of the target character string data can be set based on actual needs and are not limited in the present disclosure. In addition, the target character string data may be a specific character or character combination, or a specific prompt word, etc. The target character string data may be pre-configured by the electronic device, or may be flexibly set by the user based on his/her own needs, which is not limited in the present disclosure.

For example, the target string data can be “@AI”, “@lenovo”, “#AI#”, or other prompt strings containing set characters such as “AI”; it can also be the name of the target application, or a string containing the name of the target application, etc. The target character string data may be located at the end of the first interactive data, or may be located at other positions in the first interactive data, which is not limited in the present disclosure.

In some embodiments, in response to detecting the input of target voice segment data, determine that the first interaction data meets the target trigger condition.

The target voice segment data may also be set as needed. For example, the target voice segment data may be voice data that at least includes the name of the target processing model or the target application, or voice data that includes information that can indicate that artificial intelligence processing is required. For example, the target voice segment data may include voice information such as “using AI”, “AI” or “target application name”.

In some embodiments, in response to detecting the input target trajectory data, determine that the first interaction data meets the target trigger condition.

The target trajectory data may be any set handwriting trajectory data, and the target trajectory data may indicate that the first application or the user of the first application has a need to call the artificial intelligence function service. For example, the target trajectory data may be handwriting or strokes in the shape of the character string “AI”; or may be handwriting or touch trajectory in the shape of “L”, “artificial intelligence” or other set shapes.

In some embodiments, in response to detecting a target gesture action or target attitude change data, determine that the first interaction data meets the target trigger condition.

The target gesture action or target attitude change data may also be set as needed, and the specific set data will be different depending on the specific implementation of the gesture action and attitude detection.

For example, the target gesture action or target attitude change data can be: a long press or sliding action of two fingers sensed by a touch screen, or a click action by a stylus; or a click action of a specific button on a mouse or keyboard, etc. ; or a pre-set user gesture or action that can be recognized by a camera, a user's eye track, an attitude change of an electronic device, etc. The attitude change of the electronic device may be a change in screen angle, a change in a specific attitude, or a shake of the electronic device.

In another example, the target gesture action or target attitude change data can be: a screenshot operation, a circle selection operation, a drag operation, a floating operation, an eye tracking operation, or a word marking operation to mark at least one character, etc. For example, the screenshot operation can be an operation of taking a screenshot of at least part of the text or image displayed or input by the first application; the circle selection operation can be an operation of selecting at least part of the text or image content displayed or input by the first application; the floating operation may be an operation in which the user's finger rests on the application window of the first application or operates the floating window.

In some embodiments, in response to the behavior parameter when the first interaction data is being input meeting the corresponding parameter threshold, determine that the first interaction data meets the target trigger condition.

The behavior parameter when the first interaction data is being input may include, but is not limited to, specific behavior data parameters when the first interaction data is being input. The behavior data parameter when the first interaction data is being input may include, but is not limited to, modification, erasure, deletion, input continuity and whether there is repeated input, etc. Correspondingly, the behavior parameter meeting the corresponding parameter threshold may be that the freeze time during the input of the first interaction data exceeding a set time; it may also be that there are more than a set number of modifications, erasures, deletions or repeated inputs, etc.

It should be understood that in the above situations, the target character string data, target voice segment data, and target trajectory data can belong to the first interaction data, or can be regarded as data input after the first interaction data, which is not limited in the present disclosure.

In some embodiments, in response to the first interaction data meeting the target trigger condition, the specific implementation of outputting the target function service option in the target area of the electronic device may also have many possibilities. The following describes the data processing method of the present disclosure in combination with several possible implementation methods of determining and outputting the target function service options.

FIG. 2 is a flowchart of the data processing method according to some embodiments of the present disclosure. The method will be described in detail below.

201, detecting the first interaction data input to the first application of the electronic device.

For the implementation of the process at 201, reference can be made to the description of the process at 101, which will not be repeated here.

202, in response to the first interaction data meeting the target trigger condition, determining the target data, and outputting a target function service option for the target data in the target area of the electronic device.

In some embodiments, the target function service options may be options that can be provided by a target processing model or a target application of an electronic device for performing a target processing operation on target data.

The specific time limit for the first interaction data to meet the target trigger condition may be at least one of the several possible situations described above, which is not limited in the present disclosure.

In some embodiments, the target data may be data determined from the first interaction data or data input into the first application before the first interaction data, or data input or transmitted to the first application after the first interaction data. The data format of the target data is not limited in the present disclosure. For example, the target data may be text data, voice data, image data, or sensor signal data, etc.

Below are several example scenarios for determining the target data.

In some embodiments, the behavior parameter when the first interaction data is being input may be obtained, and the target data may be determined from the interaction data input to the first application based on the behavior parameter. The target data may be the interaction data generated by an input operation having target behavior parameters.

The interaction data input into the first application may include the first interaction data, the second interaction data, or both the first interaction data and the second interaction data. For example, the second interaction data may be data input before or after the first interaction data.

The target behavior parameter may include parameter information such as number of modifications, presence of marks, input handwriting strength, input errors, spelling errors, deletion frequency, and number of deletions. Based on this, the interactive data generated by the input operation with the target behavior parameter can be data marked by a key identifier or other means, data with spelling errors or splicing errors exceeding a set number of times, data with handwriting traces or touch input force exceeding a set force, and data in a data area with repeated deletions exceeding a set number of times.

It should be understood that if the user modifies or deletes a portion of the data entered or displayed in the first application many times, or marks it as important, it may indicate that the user is unable to effectively edit the data, correctly understand the data, or correctly enter the data. In order to accurately complete the processing of this part of the data, processing models such as artificial intelligence models or target applications with processing model functions can be used to provide at least one target function service option that can operate and process this part of the data. In this way, the user can use the target application or target processing model to efficiently process the corresponding data.

In some embodiments, a target sensitive word in the interaction data input into the first application may be used as the target data.

For reference of the interaction data input into the first application, reference can be made to the relevant description above, which will not be repeated here.

In some embodiments, the target sensitive word can be set in advance. For example, the target sensitive words may include, but are not limited to, set names of people, places, buildings, animals, objects, files, or language characters of a set country (for example, if the user frequently uses Chinese, then English and other foreign language characters can be used as target sensitive words) such that these target sensitive words can be searched, retrieved, and translated in the future.

In some embodiments, the interaction data input into the first application after the target trigger condition is met may be determined as the target data.

For example, when the target character string, target voice segment data, target trajectory data or target gesture action that meets the target trigger condition is detected, the target data may be determined as the interaction data of a paragraph or sentence input after the target character string, target voice segment data, target trajectory data or target gesture action is input, or the interaction data input within the set time period. For example, if “@AI” is detected and confirmed to meet the target trigger condition, a string of characters or a continuous piece of data entered after “@AI” can be used as the target data.

In some embodiments, the interactive data that is input before the target trigger condition is met and meets the set requirements may be determined as the target data.

For example, the interactive data that meets the set requirements can be text or pictures entered, selected or edited within a set time period before the target trigger condition is met; or the last sentence or last string entered before the target trigger condition is met.

In another example, if the target trigger condition is detected when input of the target string data is met, the target data may be the interactive data that is input before the target string data that meets the target trigger condition is input and that has a set position relationship with the target string. For example, the set position relationship may be that the target character string belongs to the same paragraph, the same sentence, or is a picture that is adjacent to the target character string.

In some embodiments, the data from the second application obtained after the target trigger condition is met may be determined as the target data.

There may be a target communication connection between the second application and the first application. In the present disclosure, the first application can interact with the second application and obtain data transmitted by the second application.

In some embodiments, the second application may be an application on the electronic device side. For example, the second application may be the application to which the electronic device jumps to when it confirms that the target trigger condition is met. In this case, the second application may be the target application described above. The second application may also be an application that the user opens or controls to jump to after confirming that the trigger condition is met and transmits data to the first application.

For example, the first application may be an instant messaging application, the second application may be a shopping application, a video player application, an audio player application, an email application, or a document application, etc., which can share data between the electronic device and the first application. Correspondingly, the data from the second application may be a link address, video content, audio data, email link, email content, or document, etc.

The second application may also be an application running on other electronic devices. For example, the first application may be an instant messaging application, and the second application may be an instant messaging application on other electronic devices. In this case, the target data may be the picture, text or video data sent by the second application to the first application after confirming that the target trigger condition is met. In another example, the first application may be a remote conference application, and the second application may be a remote conference application on other electronic devices. In this case, the target data may be conference images, text or PPT data sent by the second application to the first application after confirming that the target trigger condition is met.

In some embodiments, the data determined by the target operation acting on the window displayed data of the first application may be used as the target data.

The window displayed data includes the first interaction data and the application data of the first application. The application data of the first application may include historical input data of the first application (i.e., data input to the first application before the first interaction data), user interface data, network push data, and response data generated by the first application in response to the first interaction data.

The target operation may be a word-scribing operation, a screenshot operation, a circle selection operation, a drag operation, or a floating operation, etc. The target operation may also be a voice input operation, a gesture operation, or an eye tracking operation. Correspondingly, data targeted or input by a word-marking operation, a circle selection operation, a dragging operation, a voice input operation, a gesture operation, or an eye tracking operation may be determined as target data.

Take the first application as a document application as an example. In response to the first interaction data meeting the target trigger condition, the data selected by the circle selection operation in the document application may be used as the target data.

It should be understood that, in practical applications, the target data may be comprehensively determined by combining several of the above possible situations, which is not limited in the present disclosure.

Of course, there may be other methods for determining the target data, which is not limited in the present disclosure.

In some embodiments, the target function service options for the target data may be determined based on at least one of the content and data type of the target data, and may be provided by the target processing model or target application, such as determining the target function service options that can be realized with the help of artificial intelligence.

As described above, a function service option list for the target data may be determined, and the function service option list may include at least one target function service option.

The following is an example.

Assume that the target data is text data. In combination with this data type, it can be determined that the processing operations on text data with the help of artificial intelligence can include, but are not limited to, text editing, text expansion, text content reduction, text topic extraction, text translation, and text-based graphics such that the target function service options corresponding to these processing operations can be determined.

In another example, target data is text data, which indicates the need for raw images. In this case, based on the content of the text data, it can be determined that the target function service options may include text images and text videos.

Consistent with the present disclosure, in response to the first interactive data input into the first application meeting the target trigger condition, data content and data type of the target data to be processed can be combined to reasonably output the target function service options available in the target area of the electronic device. In this way, the target function service options can be output to realize the corresponding processing operations on the target data using the target processing model or target application.

In some embodiments, there may be many options for the target area when outputting the target function service options for the target data in the target area. Based on this, outputting the target function options for the target data in the target area may include at least one of the following possible situations.

In some embodiments, at least one target function service option for the target data may be output in a first area in the window area of the first application. In this case, the target area is the first area, and the first area belongs to the window area of the first application. There may be a target position relationship between the first area and the area where the target data is located. For example, the target location relationship may be adjacent to the area where the target area is located, or may be outside the area where the target data is located and at the edge of the window area of the first application.

In some embodiments, at least one target function service option for the target data may be output in the second area, where the second area is a pop-up window area covering a portion of the window area of the first application. That is, the second area is on a different layer from the window area of the first application, but the second area is a pop-up window area located above the window area of the first application.

In some embodiments, the target data and at least one target function service option for the target data may be output in the window area of the second application. The second application may be an application that can call the target processing model to provide target functional services. For example, the second application may be an application that is jumped to in response to the first interaction data meeting the target trigger condition. The second application can be the target application described above. In this case, the target data may be any of the target data described above. In particular, the target data may be the target data input to the second application after the target trigger condition is met.

For example, when the first interactive data input into the first application meets the target trigger condition, the jump to the second application can be triggered and the target data input into the second application can be obtained. Then, the target data can be output in the window area of the second application, and at least one target function service option for the target data can be output in the window area of the second application.

In the present disclosure, there are many methods for determining and outputting the target function service options for the target data. The following provides several example implementations to illustrate that, in actual applications, outputting target function service options for target data may include at least one of the following possible implementations.

In some embodiments, attribute information of the target data may be obtained, and at least one matching target function service option may be output in the target area based on the attribute information. The attribute information of the target data may be the data type and language type of the target data. For example, the data type of the target data can be at least one of words, long sentences, pictures, and graphic text, etc. The language type to which the target belongs can be at least one of Chinese, English, Japanese, and French, etc.

For the method of determining the target data and the target area, reference can be made to the relevant description in the foregoing embodiments, which will not be repeated here.

In some embodiments, the target function service options that may need to be provided can be determined in combination with the specific type of target data and the language category to which it belongs.

In some embodiments, the user intent represented by the target data can be determined, and at least one matching target function service option can be output in the target area based on the user intention.

In some embodiments, the user intent may be determined by identifying the user intention represented by the target data by performing intent analysis on the target data or the first interaction data. The user intent may represent the processing operation that the user wishes to perform on the target data. For example, the user intent may be translation, image generation, theme extraction, or content search, etc.

Each user intent may be suitable for at least one functional service option such that each target functional service option required to be output can be determined based on the user intention guaranteed by the target data.

In some embodiments, load resource information of the electronic device may be obtained, and at least one target function service option matching the target data may be output in the target area based on the load resource information.

The load resource information of the electronic device may include one or more of hardware configuration, software configuration, functional service configuration corresponding to the functional services that can be provided, and current resource usage of the electronic device. The load resource information of the electronic device can reflect that, assuming there are no abnormal conditions such as insufficient resources or device downtime, the electronic device is currently suitable for processing target data through the target application or target processing model.

In some embodiments, user profile information of the target user may be obtained, and at least one matching target function service option may be output in the target area based on the user profile information and the attribute information of the target data.

For details of the attribute information of the target data, reference can be made to the relevant description in the foregoing embodiments, which will not be repeated here.

The target user may be a user of the electronic device, a logged-in user of the first application, or a logged-in user of the target application. The user profile information of the target user can at least reflect the user's processing habits or processing requirements for different types of target data. Based on this, the user profile information of the target user may include the historical operation behaviors performed by the target user on different types of data and the functional service options selected, etc.

For example, user profile information may include the operations or demands that users typically initiate for vocabulary, the beautification or cropping of pictures that they typically perform, and the processing operations that users frequently perform on articles, such as generating summaries or checking for errors.

In actual applications, at least one matching target function service option can be comprehensively determined based on user profile information and attribute information of target data. Alternatively, at least one target function service option may be determined based on the attribute information of the target data. The at least one target function service option may be sorted in descending order based on the degree of matching between the target function service option and the user profile information, and the at least one target function service option may be output in the target area based on the sorting order.

If the display range of the target area is limited, the target function service options that have a low degree of matching with the user profile information may be folded and displayed first. That is, the target function service options can be first cached in the cache area to be displayed such that when the user drags or pulls down the list of target function service options, the target function service options with a lower degree of matching with the user profile information will be displayed.

In some embodiments, the source information of the target data may be obtained, and at least one matching target function service option may be output in the target area based on the source information.

The source information of the target data may at least be used to characterize the application from which the target data originates and its application type. For example, the source information of the target data may indicate that the target data originates from a browser application, a document application, a PPT application, a photo album, or a social application. Based on this, combined with the source information of the target data, different target function service options can be recommended for data from different sources.

In practical applications, the source information of the target data and the attribute information of the target attribute may be combined and output at least one matching target function service option in the target area.

For example, if the target data comes from the WeChat application and the target data is an image, then functional service options such as image beautification, raw image, and asking questions about the image can be determined as target functional service options.

In another example, if the target data comes from a PPT or document and is text, then the matching target function service options may include retrieving relevant documents, translating, or generating questions for the target data.

It should be understood that the implementation methods of determining target function service options described above can also be used in combination with each other, which is not limited in the present disclosure.

In order to facilitate understanding of the relevant content of the embodiment of FIG. 2, the following is an example of an application scenario.

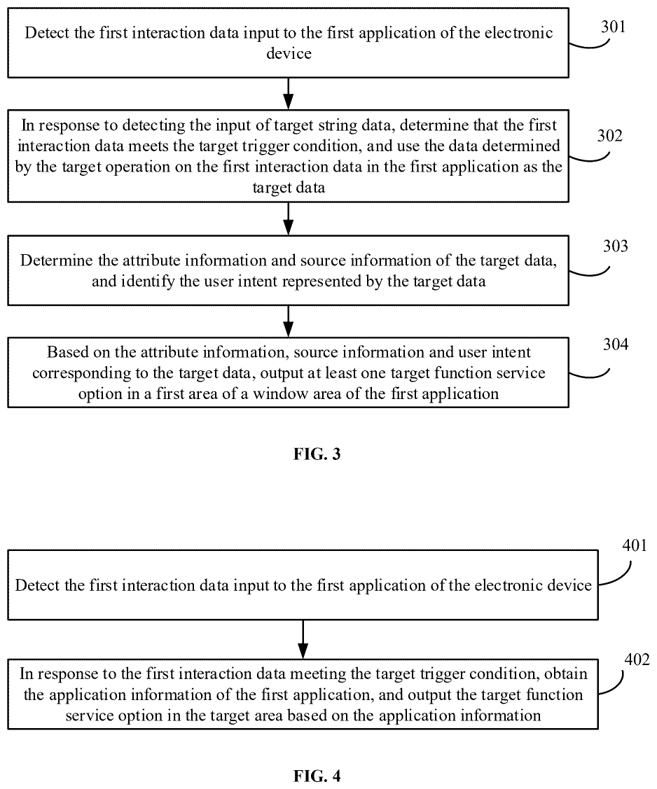

For ease of description, the following takes the first interaction data meeting the target trigger condition as the detection of the input target string data, and the data determined by the target operation acting on the window display data of the first application as the target data as an example. Considering that there are many possibilities for implementing the target function service options, an example of determining the target function service options by combining the attribute information and source information of the target data and the user intent represented by the target data is provided here. FIG. 3 is a flowchart of the data processing method in an application scenario according to some embodiments of the present disclosure. The method will be described in detail below.

301, detecting the first interaction data input to the first application of the electronic device.

The first interactive data may be a picture, text, PPT, or data containing text and pictures.

302, in response to detecting the input of target string data, determining that the first interaction data meets the target trigger condition, and using the data determined by the target operation on the first interaction data in the first application as the target data.

For example, after inputting the first interaction data, the user inputs a target character string such as “@AI” or “AI+”, and it is determined that the target trigger condition is met.

Of course, this example takes the example of the input of target character string is detected and the target trigger condition is met. The technical solution in this example also applies to the case where the target voice segment data, target trajectory data, target gesture action or target posture change data is detected, or the behavior parameter when the first interaction data is being input meets the parameter threshold.

In some embodiments, the target operation may be be a circle selection operation, a screenshot operation, or a floating operation, etc., which is not limited in the present disclosure.

Take the window display data acting on the first application as an example as the first interactive data acting on the first application. In this case, after performing the target operation on the first interaction data, data in the first interaction data targeted by the target operation may be determined as target data.

Take the first interactive data as data that includes at least an image as an example. If the user wishes to process the image in the first interactive data, after the user inputs a character string such as “@AI”, the user can select the image content to be processed from the first interactive data by circling or other methods.

It should be understood that the same approach can apply to the case where target data is determined based on the behavior parameter when the first interaction data is input, and the interaction data input into the first application or the second application after the target string is detected is determined as target data.

303, determining the attribute information and source information of the target data, and identifying the user intent represented by the target data.

It should be understood that in this example, the target data is taken as a part of the first interactive data. In this case, the target data can be data sent by other applications to the first application. The target data may also be data obtained from other local applications of the electronic device. Therefore, there may be many possibilities for the source information of the target data. For example, if the first application is an instant messaging application, and the target data is a picture transmitted by an instant messaging application on another electronic device, then the source information of the target data is the instant messaging application; if the target data is uploaded from the album, then the data source of the target data is from the album; of course, if the target data is text data input by a user, the source of the target data is the user input from the first application.

The attribute information of the target data can represent the data type, content type, format and data size of the target data. Take the target data as an image as an example, the attribute information of the target data includes at least the data type of the target data as an image, and may also include information such as the image format and the object category and object features of the objects in the image.

The user intent represented by the target data can be the user intent determined by performing intent recognition on the target data. For example, if the target data is an image, intent recognition can be performed on the image content to determine the user intent that the image content may represent. For example, if the target image contains an image of a person, the uses intent may be to beautify the target image, enlarge the image, or blur the background of the image.

In some embodiments, the user intent represented by the target data may also be the user intent represented by the first interaction data in which the target data is located, and details will not be described here.

304, based on the attribute information, source information and user intent corresponding to the target data, outputting at least one target function service option in the first area of the window area of the first application.

In some embodiments, the target function service options may be options that a target processing model or target application of an electronic device can provide for performing target processing operations on target data. For example, the target processing model may be a large language model, and the target application may be an application in an electronic device that can call the large language model or has the function of a large language model.

Take the target data as text data as an example. The attribute information, source information and user intent of the target data are text data, documents and redundancy reduction respectively. In this case, the target function service options suitable for providing through a target processing model or target application may be determined to include topic extraction, text condensation, and article condensation.

In some embodiments, the first area may be an area in the window area of the first application that is adjacent to the target data.

Of course, if the at least one target function service option is displayed through a pop-up window area within the coverage of the window area of the first application, this embodiment is also applicable. The specific process is similar and will not be repeated here.

It should be understood that after outputting the at least one target function service option, in response to the target function service option selected by the user, the target data can be processed using the target processing model or target application. The processing operation may be a processing operation that matches the target function service option selected by the user.

Further, after processing the target data, the data processing result corresponding to the target data may be displayed at the position of the input point such as the cursor when the target trigger condition is met in the first application. In this way, the data processing result can be displayed at the first application of the cursor at the current moment or the corresponding position of the cursor in other applications in the electronic device. The details are as described in the foregoing embodiments and will not be repeated here.

The data processing method of the present disclosure is described below in conjunction with another possible implementation method of outputting a target function service option in a target area of an electronic device in response to the first interaction data meeting a target trigger condition. FIG. 4 is a flowchart of the data processing method according to some embodiments of the present disclosure. The method will be described in detail below.

401, detecting the first interaction data input to the first application of the electronic device.

For the implementation of the process at 401, reference can be made to the description of the process at 101, which will not be repeated here.

402, in response to the first interaction data meeting the target trigger condition, obtaining the application information of the first application, and outputting the target function service option in the target area based on the application information.

The target function service options may be options that a target processing model or target application of an electronic device can provide for performing target processing operations on target data. The target data may come from the first interaction data or the second interaction data that is different from the first interaction data.

For the method of determining the target data, reference can be made to the relevant description in the foregoing embodiments, which will not be repeated here.

The application information of the first application may include, but is not limited to, the application identifier, application type, application configuration, and other information related to the first application. The application configuration may be used to characterize whether the first application has the ability to call the processing model, and may also characterize the functional roles that the first application can achieve.

It should be understood that the application information of the first application can represent the type or capability of the first application. Combined with the type or capability of the first application, the functional services that may need to be obtained with the help of processing models such as artificial intelligence models when the user uses the first application may be accurately determined.

For example, the first application is an image editing application. When the user uses the first application, there may be a need to use an artificial intelligence model or other processing model to edit the image displayed in the first application or generate a new image. Therefore, in the case where the first application is an image editing application, the target functional service options may include image editing, image generation, high-definition image conversion and other functional service options.

There are also many possible situations for outputting target function service options based on the application information of the first application. For example, outputting target function service options based on the application information may include one or more of the following possible situations.

In some embodiments, at least one target function service option matching the application identification information of the first application may be output in the target area.

The application identification information of the first application may be used to uniquely identify the first application. For example, the application identification information of the first application may be the name or number of the first application.

The target function service option that matches the application identification information of the first application may be determined based on the function service options historically used by the first application. For example, if the first application is a game application, the user may search for game strategies or recorded highlights while playing the game. Therefore, based on the application identification information of the first application, the matching target function service options may be determined to include searching for game strategies and generating highlight moments. In another example, the first application is an image display or image editing application. In this case, the user may edit, crop, or refine the image while using the first application, or use the editing, cropping, or refining functions of the processing model. Therefore, the matched target function service options may include image refinement function, image editing function, image cropping function, etc.

In some embodiments, at least one target function service option different from the function service that can be provided by the first application may be output in the target area based on the application configuration information of the first application.

The application configuration information of the first application may represent the functional services that the first application can provide, or the processing capabilities of the processing model that the application can call. Accordingly, based on the application configuration information of the first application, options for functional services other than the functional services that the first application itself can call or implement can be recommended to the first application.

For example, the first application is a document application. The application configuration information of the first application can reflect that the first application can provide service functions such as text input and text editing, and the functional services such as text topic extraction and content search that the first application cannot provide can also be determined. Therefore, options for target functional services such as text topic extraction and content search can be output.

In some embodiments, the user intent may be determined based on the application identification information and target data of the first application, and at least one matching target function service option may be output in the target area based on the user intention.

There are many possibilities for the specific implementation of intent analysis based on the application identification information and target data of the first application. For example, an intent recognition model can be pre-trained based on application identification information and target data samples of different application samples. Accordingly, based on the application identification information of the first application and the target data, the user intent can be determined using the intention recognition model. The intent recognition model can be any artificial intelligence model. For example, the intent recognition model can be a large language model such as llama3.

After the user intent is determined, for the specific implementation of matching at least one target function service option based on the user intent, reference can be made to the relevant description in the foregoing embodiments, which will not be repeated here.

In some embodiments, at least one matching target function service option may be output in the target area based on the operating state information of the first application.

The operating state information of the first application may be at least one piece of information related to the operating state of the first application. For example, the operating state information of the first application may be used to indicate whether the first application is stuck or in an abnormal state.

The target function service option output based on the operating state information of the first application may be an option corresponding to a function service for repairing or improving the operating state of the first application. For example, the target functional service option may be an option corresponding to a functional service for accelerating an application, improving network state, enhancing resource allocation of the first application, or improving hardware resource conditions such as memory usage.

In some embodiments, the target area may be located in or not located in the window area of the first application. For details, reference can be made to the relevant description of the target area in the embodiments shown in FIG. 1 and FIG. 2, which will not be repeated here.

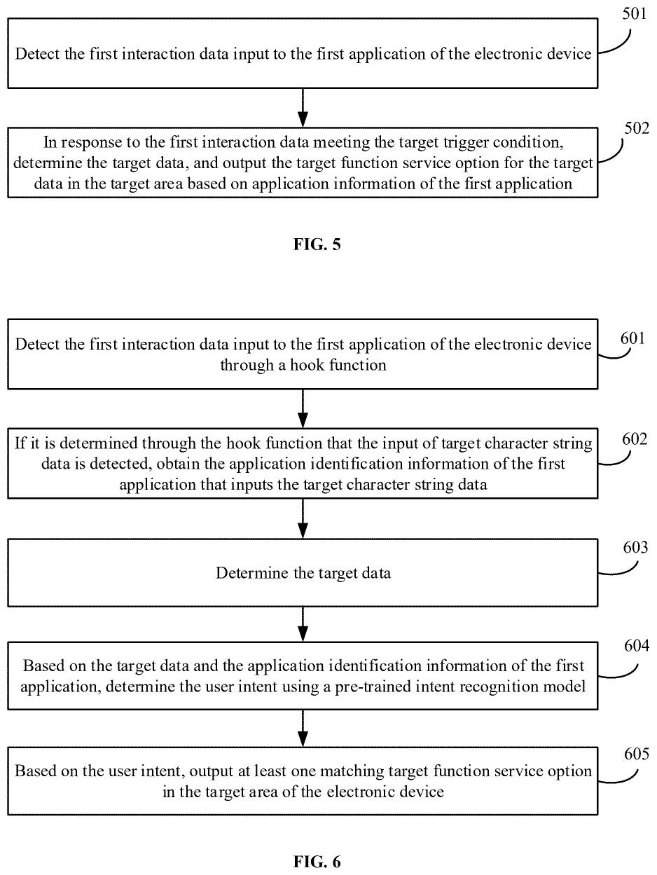

The data processing method of the present disclosure is described below in conjunction with another possible implementation method of outputting a target function service option in a target area of an electronic device in response to the first interaction data meeting a target trigger condition. FIG. 5 is a flowchart of the data processing method according to some embodiments of the present disclosure. The method will be described in detail below.

501, detecting the first interaction data input to the first application of the electronic device.

For the implementation of the process at 501, reference can be made to the description of the process at 101, which will not be repeated here.

502, in response to the first interaction data meeting the target trigger condition, determining the target data, and outputting the target function service option for the target data in the target area based on application information of the first application.

The target function service option may be an option that can be provided by a target processing model or a target application of an electronic device for performing a target processing operation on target data.

For the method of determining the target data, reference can be made to the relevant description of determining the target data in the embodiment shown in FIG. 2, which will not be repeated here.

For the application information of the first application, reference can be made to the relevant description in the foregoing embodiments, which will not be repeated here.

In this embodiment, the target function service options for the target data can be determined by combining the application information such as the type and capability of the first application. Based on this, this embodiment can be regarded as a combination of the embodiments shown in FIG. 2 and FIG. 4.

For example, the application identification information of the first application, the application configuration information and at least one of the user intentions corresponding to the application identification information and the target data can be combined with at least one of the attribute information of the target data, the load resource information of the electronic device, the user profile information and the source information of the target data to output at least one matching target function service option.

To facilitate the understanding of the embodiment shown in FIG. 5, another application scenario is described below.

For the ease of description, the following takes the case where the input of target character string is detected and the first interaction data is determined to meet the target trigger condition. In addition, the example of outputting at least one target function service option is taken by combining the application identification information of the first application and the user intention determined by the target data.

FIG. 6 is a flowchart of the data processing method in another application scenario according to some embodiments of the present disclosure. The method will be described in detail below.

601, detecting the first interaction data input to the first application of the electronic device through a hook function.

602, if it is determined through the hook function that the input of target character string data is detected, obtaining the application identification information of the first application that inputs the target character string data.

In some embodiments, the hook function may be used to detect the global keyboard messages or touch screen input messages of the electronic device to obtain the interactive data input by the user. When it is determined that the user has input the target character string data (such as “@AI”), the application identification information corresponding to the first application (i.e., the application where the input point such as the cursor is located) in which the target character string data is input can be obtained.

It should be understood that the example of detecting the data input in each application in the electronic device through the hook function is used for explanation, but obtaining the target string data input to the first application through other methods is also applicable to this embodiment.

In addition, as described above, if the target character string data is replaced with target voice segment data or target gesture action, etc., only the implementation means of detecting input needs to be adjusted, and the specific implementation can also be applied to this embodiment.

For example, the application identification information of the first application may at least include the application process name of the first application, and of course, it may also be other identification information as described above.

603, determining the target data.

The specific implementation of determining the target data may be any of the possible situations described above.

For example, the most recent sentence, the last piece of data, or the last picture input before the target character string data in the first interactive data may be determined as the target data.

In another example, the data input into the second application after the target character string data is detected may be determined as the target data. The second application may be an application to which the electronic device jumps to in response to detecting the target character string data, such as a target application. The second application may also be any other application other than the first application.

604, based on the target data and the application identification information of the first application, determining the user intent using a pre-trained intent recognition model.

605, based on the user intent, outputting at least one matching target function service option in the target area of the electronic device.

The target function service option may be an option that can be provided by a target processing model or a target application of an electronic device for performing a target processing operation on target data.

In some embodiments, the target area may be a portion of the window area of the first application, etc. Of course, it may also be any of the examples described above which will not be described in detail here.

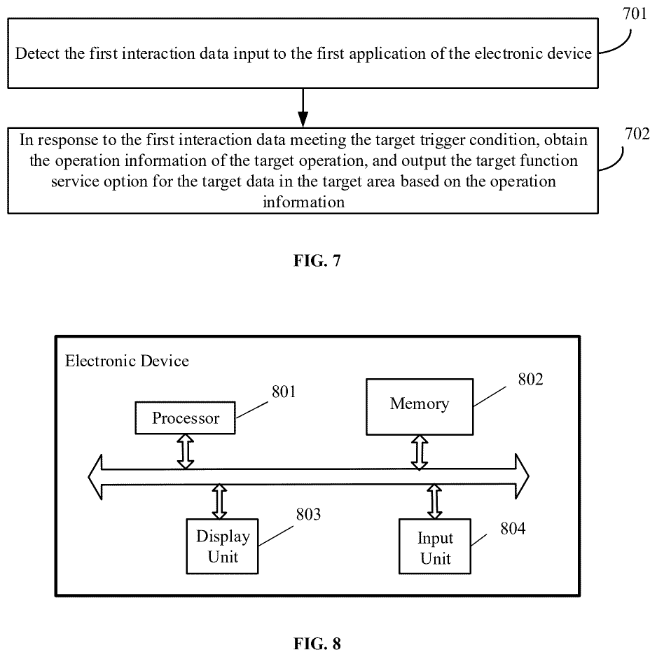

The data processing method of the present disclosure is described below in conjunction with another possible implementation method of outputting a target function service option in a target area of an electronic device in response to the first interaction data meeting a target trigger condition. FIG. 7 is a flowchart of the data processing method according to some embodiments of the present disclosure. The method will be described in detail below.

701, detecting the first interaction data input to the first application of the electronic device.

For the implementation of the process at 701, reference can be made to the description of the process at 101, which will not be repeated here.

702, in response to the first interaction data meeting the target trigger condition, obtaining the operation information of the target operation, and outputting the target function service option for the target data in the target area based on the operation information.

In some embodiments, the target function service options may be options that a target processing model or a target application of an electronic device can provide for performing target processing operations on target data.

For the method of determining the target data, reference can be made to the relevant description in the foregoing embodiments, which will not be repeated here.

The target operation may be at least used to obtain the target data. For example, the target operation may be an operation of inputting the target data. The target operation may also be an operation of dragging, moving, selecting, copying or pasting. Of course, the target operation may also include other possible target operations described above.

The operation information of the target operation may include at least one or more of the attribute information of the operation device used for the target operation, the operation characteristic information of the operation user of the target operation, the operation behavior information of the operation user, and the operation environment information.

The operating device used for the target operation may be a stylus, mouse, keyboard, touch screen, or input sensor, and the attribute information of the operating device may include the type of the operating device and the input functions that can be realized.

The operation characteristic information of the target operation user may be the operation habits, operation preferences or preferred functional services of the target operation user. The operation behavior information may include, but is not limited to, operation speed, operation behavior trajectory, and operation frequency. The operation behavior trajectory can be used to characterize the specific type of target operation. The operation frequency can reflect whether the historically recommended functional services meet the user's intent.

The operating environment information may be the external environment or scene in which the electronic device is located when the target operation is input. For example, the operating environment information may include, but is not limited to, work environment, home environment, indoor environment, outdoor environment, noise environment, audio and video playback environment, etc. When the operating environment information is different, the user's requirements for functional options when using the first application may also be different.

In some embodiments, outputting target function service options for the target data based on the operation information may include one or more of the following possible situations.

In some embodiments, at least one target function service option may be output in the target area based on the content of the target data and the information of the operating device that performs the target operation.

The content of the target data can reflect the type and content characteristics of the target data. For example, if the target data is text, then the target data is the specific content in the text. Similarly, the content of the target data can also be image content, audio content, and web page content.

The operating device information can represent the specific operating device used to implement the target operation and the model of the operating device. For example, the operating device information of the target operation can represent that the target operation is input by finger, touchpad, mouse, keyboard, stylus, handle or wearable device. If the operating device is a stylus pen, a handle, or a mouse, the operating device information may further include information such as the model of the stylus pen, the handle, or the mouse.

Under the action of different operating devices, at least one of the output target function service options may be different. That is, for different operating devices represented by the operating device information, the output target function service options may have different target function service functions.

In this implementation, both the content of the target data and the operating device information can affect the number and types of output target function service options.

In some embodiments, at least one matching target function service option may be output in the target area based on the content of the target data and the user profile information of the operating user of the target operation.

As described above, the content of the target data may be text data, image data, or PPT data.

The user profile information of the operating user may be the user habits and operating preferences of the operating user. For details, reference can be made to the previous related description and will not be repeated here.

Under the operations of different operating users, at least one of the output target function service options may be different.

Similar to the above, when combining the content of the target data and the user profile information of the user operating the target operation to output at least one target function service option, the at least one target function service option may be sorted in descending order based on the degree of matching between the target function service option and the user portrait information, and the at least one target function service option may be output in the target area based on the sorting order.

In some embodiments, at least one matching target function service option may be output in the target area based on the content of the target data and the operating environment information of the target operation.

The content of the target data is as described above.

The operating environment information of the target operation may be the scene environment of the electronic device when the target operation is performed, such as the audio-visual entertainment environment, game scene, indoor environment or outdoor environment, etc.

Under different operating environments, at least one of the output target function service options may be different.

For example, when the target data content is an image and the operating environment information is an outdoor environment, the target function service options may include a function service option for generating a video and a function service option for repairing the video. When the content of the target data is an image and the operating environment information is a conference environment, the output target function service options are not suitable for including function service options for generating a video, but may include function service options such as beautifying an image and reducing an image.

In some embodiments, when the target data includes text data, based on the operating device information and/or operating user information of the target operation, the target function service options including or excluding the target function service options for changing the data amount or type of the text data and/or for obtaining associated data of the text data may be output in the target area.

For example, the target function service option may include a function service option for changing the data volume or type of the text data, but may not include a function service option for obtaining the associated data of the text data. Or, the target function service option may not include a function service option for changing the data volume or type of the text data, but may include a function service option for obtaining associated data of the text data. Or, the target function service option may also include a function service option for changing the data volume or type of the text data and a function service option for obtaining the associated data of the text data.

The text data can be in Chinese or a foreign language, which is not limited in the present disclosure.

In some embodiments, the operating user information may include one or more of the operating user's identity and user profile information.

Changing the amount of text data may include summarizing, extracting topics, or deleting content from text data (such as an article or a paragraph); or expanding, continuing, or enriching text data (such as a string or a sentence). Accordingly, the target function service option of changing the data volume of text data may be an option for triggering content summarization, theme extraction, content deletion, content expansion, and content continuation.

In some embodiments, the target function service option for changing the type of text data may be a function service option such as a text image, a text video, or a text animation.

In some embodiments, the target function service option for obtaining the associated data of the text data may be an option for triggering a search, question, query, or translation of the text data.

In some embodiments, when the target data includes image data, based on the operating device information and/or the operating user information of the target operation, the target function service options including or excluding the target function service options for changing the amount or type of image data and/or for acquiring associated data of the image data may be output in the target area.

In some embodiments, changing the data volume of the image data may include reducing or increasing the data volume of the image data by changing image parameters of the image. For example, changing the image data volume can be achieved by retouching, adjusting exposure, adjusting clarity, adjusting saturation, changing the image theme, or adjusting the background color. Correspondingly, the target function service options may be options for implementing photo editing, adjusting exposure, or adjusting saturation, etc.

Similarly, the target function service option of changing the image type may be an option for triggering the execution of image-generated image, image-generated video or image-generated comic.

The associated data of the image data may be obtained by asking questions based on the image, searching for similar images, or tracing the image source. Correspondingly, the target function service options may be options for triggering questions about images, searching for similar images, or tracing the source of images.

In some embodiments, when the target data includes the access address, based on the target operating device information and/or the operating user information, the target function service options including or excluding the target function service options for changing the access method or output type of the content corresponding to the access address may be output in the target area.

In some embodiments, the access address may be a hyperlink or a uniform resource locator (URL) address.

The access method of the content corresponding to the access address refers to the method of accessing the content corresponding to the access address. For example, if the access method for the content corresponding to the access address is to click on the access address to access the content corresponding to the access address. Then the access method can be adjusted to locate by hovering the mouse and then triggering by a specific control or physical button to obtain the summary or key information corresponding to the content of the access address. This allows users to obtain the content pointed to by the access address without having to click on the access address.

The output type of the content corresponding to the access address may be in the form of a hyperlink, a graphic link, or a summary graphic. For example, if the output type of the content corresponding to the access address is output in the form of a hyperlink, the target function service option for changing the output type may be an option for changing the output type of the content corresponding to the access address to an image-text link output.

In some embodiments, when the target data includes media playback data, based on the operating device information and/or the operating user information of the target operation, the target function service options including or excluding the target function service options for changing the playback parameters of the media playback data may be output in the target area.

In some embodiments, the media playback data may include at least one of media data such as audio data, video data, and animation data.

In some embodiments, changing the playback parameters of the media playback data may include changing the frame rate, playback speed, volume, and size (such as the size of an animation screen) of the media playback data.

In some embodiments, when the target data includes text data and image data, based on the operating device information and/or operating user information of the target operation, the target function service options including or excluding the target function service options for layout design or content generation of text data and image data may be output in the target area.

In some embodiments, performing layout design on the text data and the image data may include designing at least one of the typesetting, proportional relationship, and positional relationship of the text data and the image data.

In some embodiments, generating content from text data and image data may be generating a document, a PPT, an image, or a video based on the text data and the image data.

In some embodiments, the target area may or may not be located in the window area of the first application. For details, reference can be made to the relevant description in the foregoing embodiments, which will not be repeated here.

It should be understood that in any of the above data processing method embodiments, the first interactive data meeting the target trigger condition may also trigger the first application to output a window such as a menu or a toolbar. For ease of distinction, the window output by the first application in response to the first interaction data meeting the target trigger condition may be referred to as the first window.

Based on this, when outputting the target area, there is a need to avoid mutual obstruction between the target area and the first window output by the first application that prevents the user from fully understanding the target function service options in the target area or from clearly seeing the content in the first window.

In some embodiments, if the first application outputs the first window in response to the first interaction data meeting the target trigger condition, the position relationship between the target area and the first window may be adjusted. By adjusting the position relationship between the target area and the first window, there is no overlap between the first window and the target area, and naturally there is no mutual occlusion. For example, based on the position of the first window in the display interface, the position of the target area can be adjusted such that the target area and the first window do not overlap or block each other.

In some embodiments, if the first application outputs the first window in response to the first interaction data meeting the target trigger condition, the display parameters of the first window may be adjusted based on the target function service option output in the target area, or processing the display content of the first window.

In some embodiments, adjusting the display unit of the first window may include adjusting the transparency of the first window such that the first window cannot block the target function service option displayed in the target area. In addition, adjusting the display unit of the first window may also include merging the first window with the window area of the first application, or adjusting the size of the first window to avoid overlapping between the first window and the target area.

Processing the display content of the first window may include deleting part of the content in the first window, or adding part or all of the target function service options in the target area to the first window such that the target function service options are not blocked by the content of the first window.

An embodiment of the present disclosure also provides an electronic device. FIG. 8 is a schematic structural diagram of an electronic device according to some embodiments of the present disclosure.

As shown in FIG. 8, the electronic device includes one or more processors 801 and one or more large model file to be executed by the one or more processors 801. The large model file can be called by at least one application running on the electronic device to perform one or more of the processes of detecting the first interaction data input to the first application of the electronic device, and in response to the first interaction data meeting the target trigger condition, outputting a target function service option in the target area of the electronic device.

In some embodiments, the target function service option may be an option that can be provided by a target processing model or a target application of an electronic device for performing a target processing operation on target data.

In some embodiments, the target data may come from the first interaction data or the second interaction data that is different from the first interaction data.

For example, the application in the electronic device can monitor the first interactive data input to the first application of the electronic device and run the large model file to perform the above processing operations.

In another example, the application can execute the above processing operations by running a large language file.

As shown in FIG. 8, the electronic device also includes a memory 802 connected to the one or more processors 801. The memory 802 can be used to store the large model file.

It should be understood that the electronic device may further include a display unit 803 and an input unit 804.

Of course, the electronic device may also include more or fewer components than those shown in FIG. 8. The components in the electronic device are not limited in the present disclosure.

In some embodiments, the electronic device may include a first body and a second body that are rotatably connected. At least one of the first body and the second body have a display screen that can be used to output a target function service option in a target area on the display screen. Outputting the target function service option in the target area may include one or more of, in response to the first interaction data meeting the target trigger condition, determining that target data, and outputting the target function service option for the target data in the target area; in response to the first interaction data meeting the target trigger condition, obtaining the application information of the first application, and outputting the target function service option in the target area based on the application information; in response to the first interaction data meeting the target trigger condition, determining target data, and outputting the target function service option for the target data in the target area based on the application information of the first application; in response to the first interaction data meeting the target trigger condition, obtaining operation information of the target operation, and outputting the target function service option for the target data in the target area based on the operation information. In some embodiments, the target operation may be at least used to obtain the target data.

In some embodiments, the target area may be located in or not located in the window area of the first application.

For the relevant operations performed by the electronic device, reference can be made to the relevant description of the foregoing embodiments, which will not be repeated here.

An embodiment of this application further provides a computer program product. The computer program product includes computer-readable instructions. When executed by an electronic device, the computer-readable instructions can cause the electronic device to perform any data processing method described in the foregoing embodiments.

An embodiment of this application further provides a computer-readable storage medium. The computer-readable storage medium carries one or more computer programs. When executed by an electronic device, the one or more computer programs can cause the electronic device to perform any data processing method described in the foregoing embodiments.

In addition, it should be noted that the embodiment described is merely an example. The units described as separate parts may or may not be physically separate, and parts displayed as units may or may not be physical units, may be located in one position, or may be distributed on a plurality of network units. Some or all the modules may be selected based on an actual requirement to achieve the objectives of the solutions of the embodiments. In addition, in the accompanying drawings of the apparatus embodiments provided in this application, connection relationships between modules indicate that the modules have communication connections with each other, which may be specifically implemented as one or more communication buses or signal cables.

Based on the description of the foregoing implementations, a person skilled in the art may clearly understand that this application may be implemented by software in addition to necessary universal hardware, or by dedicated hardware, including a dedicated integrated circuit, a dedicated CPU, a dedicated memory, a dedicated component, and the like. Generally, any function that can be performed by a computer program can be easily implemented by using corresponding hardware. Moreover, a specific hardware structure used to achieve a same function may be in various forms, for example, in a form of an analog circuit, a digital circuit, or a dedicated circuit. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a USB flash drive, a removable hard disk, a ROM, a RAM, a magnetic disk, or an optical disc of a computer, and includes several instructions for instructing a computer device (e.g., a personal computer, a training equipment, a network equipment, etc.) to perform the methods described in embodiments of the present disclosure.

All or some of the foregoing embodiments may be implemented by using software, hardware, firmware, or any combination thereof. When software is used to implement the embodiments, all or a part of the embodiments may be implemented in a form of a computer program product.

The computer program product includes one or more computer instructions. When the computer program instructions are loaded and executed on the computer, the procedures or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, communication apparatus, computing device, or data center to another website, computer, communication apparatus, computing device, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a communication apparatus or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

What is claimed is:

1. A data processing method comprising:
detecting first interaction data input to a first application of an electronic device; and
in response to the first interaction data meeting a target trigger condition, outputting a target function service option in a target area of the electronic device, wherein:
the target function service option is an option provided by a target processing model or a target application of the electronic device for performing a target processing operation on target data, and
the target data are associated with the first interaction data or second interaction data that is different from the first interaction data.

2. The method of claim 1, wherein the first interaction data meeting the target trigger condition includes one or more of:
in response to detecting input of target character string data, determining that the first interaction data meets the target trigger condition;
in response to detecting input of target voice segment data, determining that the first interaction data meets the target trigger condition;
in response to detecting input of target trajectory data, determining that the first interaction data meets the target trigger condition;
in response to detecting input of a target gesture action or target attitude change data, determining that the first interaction data meets the target trigger condition; and
in response to a behavior parameter when the first interaction data is being input meeting a corresponding parameter threshold, determining that the first interaction data meets the target trigger condition.

3. The method of claim 1, wherein outputting the target function service option includes one or more of:
in response to the first interaction data meeting the target trigger condition, determining the target data, and outputting the target function service option for the target data in the target area;
in response to the first interaction data meeting the target trigger condition, obtaining application information of the first application, and outputting target function service option in the target area based on the application information;
in response to the first interaction data meeting the target trigger condition, determining the target data, and outputting the target function service option for the target data in the target area based on the application information of the first application;
in response to the first interaction data meeting the target trigger condition, obtaining operation information of a target operation, and outputting the target function service option for the target data in the target area based on the operation information, the target operation being at least used to obtain the target data, wherein:
target area is located in or not located in a window area of the first application.

4. The method of claim 3, wherein determining the target data includes one or more of:
obtaining the behavior parameter when the first interaction data is being input, and determining the target data from the interaction data input to the first application based on the behavior parameter, the target data being the interaction data generated by an input operation with a target behavior parameter;
using a target sensitive word in the interactive data input to the first application as the target data;
determining the interactive data input to the first application after meeting the target trigger condition as the target data;
determining data from a second application obtained after the target trigger condition is met as the target data, the second application having a target communication connection with the first application; and
using data determined by the target operation on window display data of the first application as the target data, the window display data including the first interaction data and application data of the first application.

5. The method of claim 3, wherein outputting the target function service option for the target data in the target area includes one or more of:
outputting at least one target function service option for the target data in a first area of the window area of the first application, the first area having a target position relationship with an area where the target data is located;
outputting at least one target function service option for the target data in a second area, the second area being a pop-up window area covering part of the window area of the first application;
outputting the target data and at least one target function service option for the target area in a window area of the second application, the second application being an application for calling the target processing mode to provide a target function service′ obtaining attribute information of the target data, and outputting at least one matching target function service option in the target area based on the attribute information;
identifying a user intent represented by the target data, and outputting at least one target function service option in the target area based on the user intent;
obtaining load resource information of the electronic device, and outputting at least one target function service option matching the target data in the target area based on the load resource information;
obtaining user profile information of a target user, and outputting at least one matching target function service option in the target area based on the user profile information and the attribute information of the target data; and
obtaining source information of the target data, and outputting at least one matching target function service option in the target area based on the source information.

6. The method of claim 3, wherein outputting the target function service option in the target area based on the application information of the first application includes one or more of:
outputting at least one target function service option matching application identification information of the first application in the target area;
outputting at least one target function service option in the target area that is different from the function service provided by the first application based on application configuration information of the first application;
determining the user intent based on the application identification information of the first application and the target data, and outputting at least one matching target function service option in the target area based on the user intent; and
outputting at least one matching target function service option in the target area based on operating state information of the first application.

7. The method of claim 3, wherein outputting the target function service option for the target area based on the operation information includes one or more of:
outputting at least one target function service option in the target area based on content of the target data and operating device information of the target operation, at least one of the output target function service options being different under the action of different operating devices;
outputting at least one matching target function service option in the target area based on the content of the target data and the user profile information of an operating user of the target operation, at least one of the output target function service options being different under the operation of different operating users;
outputting at least one matching target function service option in the target area based on the content of the target data and operating environment information of the target operation, at least one of the output target function service options being different under different operating environments;
when the target data includes text data, based on the operating device information and/or operating user information of the target operation, outputting the target function service options including or excluding a target function service option for changing a data amount or type of the text data and/or for obtaining associated data of the text data in the target area;
when the target data includes image data, based on the operating device information and/or the operating user information of the target operation, outputting the target function service options including or excluding a target function service option for changing a data amount or type of the image data and/or for obtaining associated data of the image data in the target area;
when the target data includes an access address, based on the operating device information and/or the operating user information of the target operation, outputting the target function service options including or excluding a target function service option for changing an access method or an output type of the content corresponding to the access address in the target area;
when the target data includes media playback data, based on the operating device information and/or the operating user information of the target operation, outputting the target function service options including or excluding a target function service option for changing a playback parameter of the media playback data in the target area; and
when the target data includes the text data and the image data, based on the operating device information and/or the operating user information of the target operation, outputting the target function service options including or excluding a target function service option for performing layout design or content generation on the text data and the image data in the target area.

8. The method of claim 1 further comprising:
in response to the first application outputting a first window in response to the first interaction data meeting the target trigger condition, adjusting a position relationship between the target area and the first window;
in response to the first application outputting the first window in response to the first interaction data meeting the target trigger condition, adjusting a display parameter of the first window based on the target function service option output in the target area, or processing display content of the first window.

9. An electronic device comprising:
one or more processors; and
one or more large model files to be run on the more of more processors, the one or more large model files that, when ran by one or more applications running on the electronic device, cause the one or more processors to:
detect first interaction data input to a first application of the electronic device; and
in response to the first interaction data meeting a target trigger condition, output a target function service option in a target area of the electronic device, wherein:
the target function service option is an option provided by a target processing model or a target application of the electronic device for performing a target processing operation on target data, and
the target data are associated with the first interaction data or second interaction data that is different from the first interaction data.

10. The electronic device of claim 9, wherein:
the electronic device includes a first body and a second body that are rotatably connected, one or more of the first body and second body has a display screen to output the target function service option in the target area on the display screen; and
the one or more processors are further configured to execute one or more of:
in response to the first interaction data meeting the target trigger condition, determining the target data, and outputting the target function service option for the target data in the target area;
in response to the first interaction data meeting the target trigger condition, obtaining application information of the first application, and outputting target function service option in the target area based on the application information;
in response to the first interaction data meeting the target trigger condition, determining the target data, and outputting the target function service option for the target data in the target area based on the application information of the first application;
in response to the first interaction data meeting the target trigger condition, obtaining operation information of a target operation, and outputting the target function service option for the target data in the target area based on the operation information, the target operation being at least used to obtain the target data, wherein:
target area is located in or not located in a window area of the first application.

11. The electronic device of claim 9, wherein the first interaction data meeting the target trigger condition includes one or more of:
in response to detecting input of target character string data, determining that the first interaction data meets the target trigger condition;
in response to detecting input of target voice segment data, determining that the first interaction data meets the target trigger condition;
in response to detecting input of target trajectory data, determining that the first interaction data meets the target trigger condition;
in response to detecting input of a target gesture action or target attitude change data, determining that the first interaction data meets the target trigger condition; and
in response to a behavior parameter when the first interaction data is being input meeting a corresponding parameter threshold, determining that the first interaction data meets the target trigger condition.

12. The electronic device of claim 10, wherein the one or more processors are further configured to execute one or more of:
obtaining the behavior parameter when the first interaction data is being input, and determining the target data from the interaction data input to the first application based on the behavior parameter, the target data being the interaction data generated by an input operation with a target behavior parameter;
using a target sensitive word in the interactive data input to the first application as the target data;
determining the interactive data input to the first application after meeting the target trigger condition as the target data;
determining data from a second application obtained after the target trigger condition is met as the target data, the second application having a target communication connection with the first application; and
using data determined by the target operation on window display data of the first application as the target data, the window display data including the first interaction data and application data of the first application.

13. The electronic device of claim 10, wherein the one or more processors are further configured to one or more of:
outputting at least one target function service option for the target data in a first area of the window area of the first application, the first area having a target position relationship with an area where the target data is located;
outputting at least one target function service option for the target data in a second area, the second area being a pop-up window area covering part of the window area of the first application;
outputting the target data and at least one target function service option for the target area in a window area of the second application, the second application being an application for calling the target processing mode to provide a target function service;
obtaining attribute information of the target data, and outputting at least one matching target function service option in the target area based on the attribute information;
identifying a user intent represented by the target data, and outputting at least one target function service option in the target area based on the user intent;
obtaining load resource information of the electronic device, and outputting at least one target function service option matching the target data in the target area based on the load resource information;
obtaining user profile information of a target user, and output at least one matching target function service option in the target area based on the user profile information and the attribute information of the target data; and
obtaining source information of the target data, and output at least one matching target function service option in the target area based on the source information.

14. The electronic device of claim 10, wherein the one or more processors are further configured to execute one or more of:
outputting at least one target function service option matching application identification information of the first application in the target area;
outputting at least one target function service option in the target area that is different from the function service provided by the first application based on application configuration information of the first application;
determining the user intent based on the application identification information of the first application and the target data, and output at least one matching target function service option in the target area based on the user intent; and
outputting at least one matching target function service option in the target area based on operating state information of the first application.

15. The electronic device of claim 10, wherein the one or more processors are further configured to execute one or more of:
outputting at least one target function service option in the target area based on content of the target data and operating device information of the target operation, at least one of the output target function service options being different under the action of different operating devices;
outputting at least one matching target function service option in the target area based on the content of the target data and the user profile information of an operating user of the target operation, at least one of the output target function service options being different under the operation of different operating users;
outputting at least one matching target function service option in the target area based on the content of the target data and operating environment information of the target operation, at least one of the output target function service options being different under different operating environments;
when the target data includes text data, based on the operating device information and/or operating user information of the target operation, outputting the target function service options including or excluding a target function service option for changing a data amount or type of the text data and/or for obtaining associated data of the text data in the target area;
when the target data includes image data, based on the operating device information and/or the operating user information of the target operation, outputting the target function service options including or excluding a target function service option for changing a data amount or type of the image data and/or for obtaining associated data of the image data in the target area;
when the target data includes an access address, based on the operating device information and/or the operating user information of the target operation, outputting the target function service options including or excluding a target function service option for changing an access method or an output type of the content corresponding to the access address in the target area;
when the target data includes media playback data, based on the operating device information and/or the operating user information of the target operation, outputting the target function service options including or excluding a target function service option for changing a playback parameter of the media playback data in the target area; and
when the target data includes the text data and the image data, based on the operating device information and/or the operating user information of the target operation, outputting the target function service options including or excluding a target function service option for performing layout design or content generation on the text data and the image data in the target area.

16. The electronic device of claim 9, wherein the one or more processors are further configured to:
in response to the first application outputting a first window in response to the first interaction data meeting the target trigger condition, adjust a position relationship between the target area and the first window; or,
in response to the first application outputting the first window in response to the first interaction data meeting the target trigger condition, adjust a display parameter of the first window based on the target function service option output in the target area, or process display content of the first window.

17. A computer readable storage medium storing a plurality of computer instructions that, when being executed by one or more processors, cause the one or more processors to:
detect first interaction data input to a first application of the electronic device; and
in response to the first interaction data meeting a target trigger condition, output a target function service option in a target area of the electronic device, wherein:
the target function service option is an option provided by a target processing model or a target application of the electronic device for performing a target processing operation on target data, and
the target data are associated with the first interaction data or second interaction data that is different from the first interaction data.

18. The computer readable storage medium of claim 17, wherein:
the electronic device includes a first body and a second body that are rotatably connected, one or more of the first body and second body has a display screen to output the target function service option in the target area on the display screen; and
the one or more processors are further configured to execute one or more of:
in response to the first interaction data meeting the target trigger condition, determining the target data, and outputting the target function service option for the target data in the target area;
in response to the first interaction data meeting the target trigger condition, obtaining application information of the first application, and outputting target function service option in the target area based on the application information;
in response to the first interaction data meeting the target trigger condition, determining the target data, and outputting the target function service option for the target data in the target area based on the application information of the first application;
in response to the first interaction data meeting the target trigger condition, obtaining operation information of a target operation, and outputting the target function service option for the target data in the target area based on the operation information, the target operation being at least used to obtain the target data, wherein:
target area is located in or not located in a window area of the first application.

19. The computer readable storage medium of claim 17, wherein the first interaction data meeting the target trigger condition includes one or more of:
in response to detecting input of target character string data, determining that the first interaction data meets the target trigger condition;
in response to detecting input of target voice segment data, determining that the first interaction data meets the target trigger condition;
in response to detecting input of target trajectory data, determining that the first interaction data meets the target trigger condition;
in response to detecting input of a target gesture action or target attitude change data, determining that the first interaction data meets the target trigger condition; and
in response to a behavior parameter when the first interaction data is being input meeting a corresponding parameter threshold, determining that the first interaction data meets the target trigger condition.

20. The computer readable storage medium of claim 18, wherein the one or more processors are further configured to execute one or more of:
obtaining the behavior parameter when the first interaction data is being input, and determining the target data from the interaction data input to the first application based on the behavior parameter, the target data being the interaction data generated by an input operation with a target behavior parameter;
using a target sensitive word in the interactive data input to the first application as the target data;
determining the interactive data input to the first application after meeting the target trigger condition as the target data;
determining data from a second application obtained after the target trigger condition is met as the target data, the second application having a target communication connection with the first application; and
using data determined by the target operation on window display data of the first application as the target data, the window display data including the first interaction data and application data of the first application.
